(19) United States
(12) Patent Application Publication
(10) Pub. No.: US 2017/0212991 A1
(43) Pub. Date: Jul. 27, 2017

(54) METHOD FOR MONITORING HEALTH CONDITION OF A SUBJECT AND A DEVICE THEREOF

(71) Applicant: Wipro Limited, Bangalore (IN)

(72) Inventor: Ramesh CHALLAPALLI, Chennai (IN)

(73) Assignee: Wipro Limited

(21) Appl. No.: 15/064,850

(22) Filed: Mar. 9, 2016

(30) Foreign Application Priority Data
Jan. 21, 2016 (IN) 201641002339

(51) Int. Cl. G06F 19/00

(52) U.S. Cl. CPC G06F 19/322; G06F 19/3418

(57) ABSTRACT

The present disclosure relates to a method and device for monitoring health condition of a subject. A health monitoring device receives physiological data from one or more sensors placed on the subject. The physiological data is analyzed to generate one or more patterns. The patterns are associated with time stamp information and location information. The health monitoring device detects critical condition of the patient if the pattern matches with one of one or more predefined patterns. Thereafter, the health monitoring device provides dynamically a notification about the critical health condition of the subject to at least one of the subject and one or more care providers of the subject in the vicinity of the location of the subject.

### TECHNICAL FIELD

The present subject matter is related, in general to health monitoring, and more particularly, but not exclusively to a method and a device for monitoring health condition of a subject based on the subject's activity, location and situation.

### BACKGROUND

Advances in the field of electronics over the past several years have brought about significant changes in medical diagnostic and monitoring equipment, including arrangements for self-care and remote monitoring of various chronic diseases. By remote monitoring, the patient may sit at home and still be monitored by the physicians remotely. This requires placing one or more sensors on the patient and continuously collecting the data from the sensors for monitoring patient's condition. This avoids the need of the patients visiting the physicians frequently.

Despite the many benefits of remote patient monitoring devices, healthcare providers are currently unable to identify the events or the situations affecting the health condition of the patient and accordingly provide recovery suggestions to the patient.

The existing remote monitoring devices do not take into account the patterns of the patient behavior which changes based on the location and time for providing the precautions.

The issues mainly faced in remote health monitoring are to detect patterns based on behavior of the patient which are specific to location, time and situation and accordingly suggest precautions to the patient.

### SUMMARY

Disclosed herein is a method and device for monitoring health condition of a subject. The device receives physiological data from one or more sensors placed on the subject. The device generates patterns based on the physiological data. The patterns are associated with time-stamp information and location information of the subject. Based on the pattern, the device detects critical condition of the subject and accordingly a notification is provided to care providers of the subject who are in the vicinity of the subject.

Accordingly, the present disclosure relates to a method for monitoring health condition of a subject. The method comprises receiving, by a health monitoring device, physiological data from one or more sensors placed on the subject. The method further comprises analyzing the physiological data to generate one or more patterns, wherein each of the one or more patterns is associated with time-stamp information and location information of the subject. The method further comprises detecting critical health condition of the subject if the one or more patterns match with one of one or more predefined patterns. Thereafter, a notification is provided dynamically about the critical health condition of the subject to at least one of the subject and one or more care providers of the subject in the vicinity of the location of the subject.

Further, the present disclosure relates to a health monitoring device for monitoring health condition of a subject. The health monitoring device comprises a processor and a memory communicatively coupled to the processor, wherein the memory stores processor-executable instructions, which, on execution, causes the processor to receive physiological data from one or more sensors placed on the subject. The health monitoring device analyzes the physiological data to generate one or more patterns, wherein each of the one or more patterns is associated with time-stamp information and location information of the subject. Thereafter, the health monitoring device detects critical health condition of the subject if the one or more patterns match with one of one or more predefined patterns. If the critical health condition of the subject is detected, the health monitoring device provides a notification dynamically about the critical health condition of the subject to at least one of the subject and one or more care providers of the subject in the vicinity of the location of the subject.

Furthermore, the present disclosure relates to a non-transitory computer readable medium including instructions stored thereon that when processed by at least one processor cause a health monitoring device to perform the acts of receiving physiological data from one or more sensors placed on a subject. The instructions cause the processor to analyze the physiological data to generate one or more patterns, wherein each of the one or more patterns is associated with time-stamp information and location information of the subject. The instructions cause the processor to detect critical health condition of the subject if the one or more patterns match with one of one or more predefined patterns. Thereafter, the instructions cause the processor to provide a notification dynamically about the critical health condition of the subject to at least one of the subject and one or more care providers of the subject in the vicinity of the location of the subject.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIGS. 1a-1b illustrates environment for monitoring health condition of a subject in accordance with some exemplary embodiments of the present disclosure;

FIG. 1c shows a detailed block diagram illustrating a health monitoring device in accordance with some embodiments of the present disclosure;

FIG. 2 illustrates a flowchart showing a method for monitoring health condition of a subject in accordance with some embodiments of the present disclosure; and

FIG. 3 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however that it is not intended to limit the disclosure to the particular forms disclosed, but on the contrary, the disclosure is to cover all modifications, equivalents, and alternative falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

The present disclosure relates to a method and a device for monitoring health condition of a subject. One or more sensors are placed on the subject for monitoring physiological condition of the subject. A health monitoring device receives physiological data from one or more sensors and based on physiological data generates one or more patterns. The pattern is associated with time stamp information and location information of the subject i.e the time at which the physiological data was collected and how the physiological data varies over different time period and also the location of the subject i.e the location of the subject because of which the physiological data varies. The health monitoring device detects if the subject is suffering from a critical condition or not by comparing the patterns with predefined patterns. If the pattern matches with predefined pattern, the health monitoring device detects that the subject is suffering from critical health condition. Therefore, the health monitoring device provides a notification to care providers of the subject, who are in the vicinity of the subject, to take immediate action on the subject.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

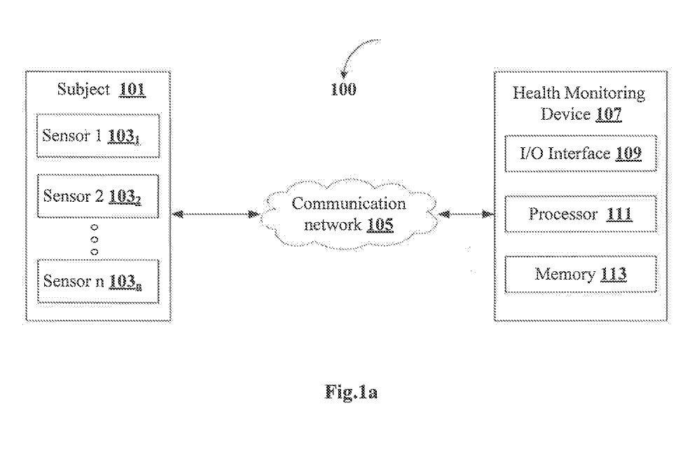

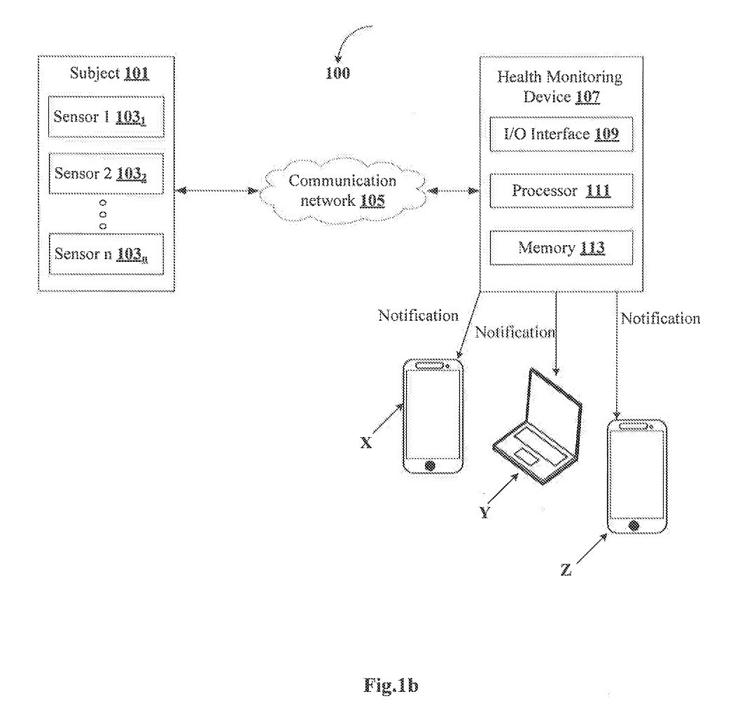

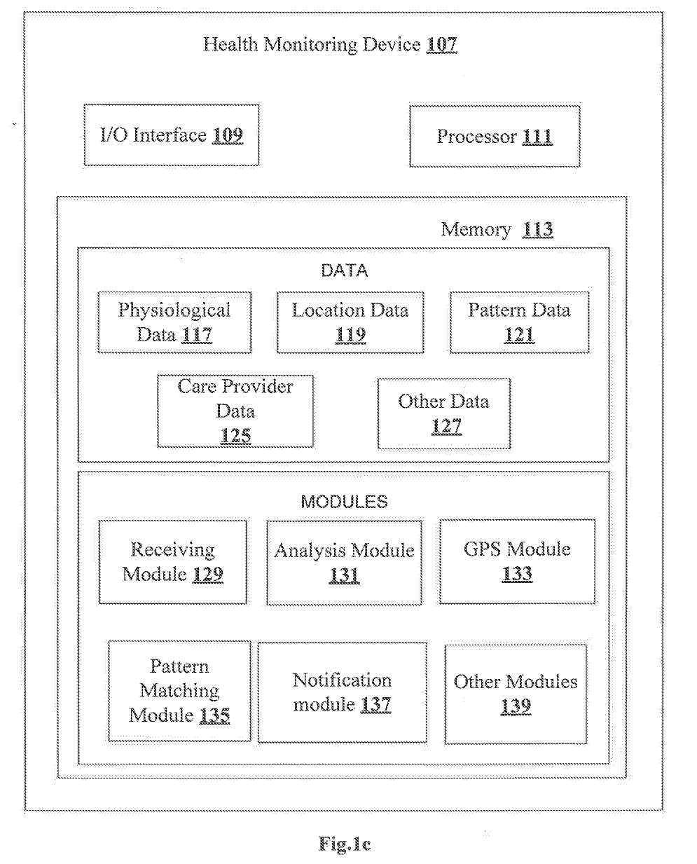

FIG. 1a illustrates environment for monitoring health condition of a subject in accordance with some exemplary embodiments of the present disclosure.

The environment 100 comprises a subject namely subject 101, one or more sensors, sensor 1 103₁ to sensor n 103n (collectively referred as sensors 103), a communication network 105 and a health monitoring device 107. The one or more sensors 103 are placed on the subject 101. As an example, the subject 101 refers to a person. As an example, the sensors 103 may include, but not limited to, Blood Pressure monitoring sensor, respiratory rate sensor and temperature sensor. The sensors 103 are configured to provide physiological data to the health monitoring device 107 through the communication network 105. The health monitoring device 107 comprises an I/O interface 109, a processor 111 and a memory 113. The I/O interface 109 is configured to receive the physiological data from the sensors 103. The received physiological data is stored in the memory 113. In an embodiment, the health monitoring device 107 receives information from the subject 101 which is stored in the memory 113 of the health monitoring device 107. As an example, the information includes but not limited to, name, age, food habits, health issues, previous health reports, care providers of subject etc.

In an exemplary embodiment, a blood pressure sensor is placed on the subject 101 for monitoring blood pressure level of the subject 101. The blood pressure sensor provides blood pressure readings also referred as physiological data of the subject 101 to the health monitoring device 107. The physiological data is associated with time stamp information and location information i.e the time at which the blood pressure readings were taken by the blood pressure sensor and the location of the subject 101 when the physiological data was provided to the health monitoring device 107. The location information is provided by a Global Positioning System (GPS) module associated with the blood pressure sensor. The GPS module continuously tracks the location of the subject 101. The health monitoring device 107 analyses the physiological data and generates one or more patterns. As an example, the pattern refers to blood pressure readings of the subject 101. The blood pressure pattern may change based on the location and activities of the subject 101. As an example, the blood pressure pattern of the subject 101 received at time “3 pm” is 140/89. The location detected by the GPS module is “office”. This pattern is compared with one or more predefined patterns as shown in the below Table 1. Each predefined pattern is associated with one or more precautions. The patterns are predefined for each subject by the health monitoring device 107 by learning the behaviour of the subject 101 in one or more places and over a period of time. For example, the one or more patterns which are predefined for subject 101 are as shown in the Table 1 below. The predefined blood pressure pattern is the threshold blood pressure pattern/critical blood pressure pattern which is learnt for the subject 101. In an embodiment, the predefined pattern may be changed or updated based on the lifestyle of the subject 101.

In an alternative embodiment, the predefined pattern may also be provided by the subject 101.

TABLE 1

| | Predefined blood | | |
|---|---|---|---|
| Subject | pressure Pattern | Location | Time |
| Subject | 123/85 | Home | 9 am |
| | 140/89 | Office | 3 pm |
| | 180/120 | Gym | 8 pm |

The pattern matches with one of the one or more predefined patterns. Therefore, the health monitoring device 107 detects critical health condition of the subject 101. The health monitoring device 107 also receives input from the subject 101 to detect one or more activities responsible for the critical condition of the subject 101. As an example, the subject 101 may provide the input as “stress at office” as the activity responsible for the critical condition of the subject 101. The health monitoring device 107 provides a notification about the critical health condition of the subject 101 to at least one of the subject 101 and care providers, who are in the vicinity of the subject 101. In an embodiment, the care providers may be preconfigured for one or more locations of the subject 101 as shown in below Table 2.

TABLE 2

| Subject | Location | Care Providers |
|---|---|---|
| Subject | Home | A,B,C |
| | Office | X,Y,Z |
| | Gym | D,E,F |

Since the subject 101 is at “office” and the critical condition has been detected, the notification is provided to the care providers namely “X”, “Y” and “Z” as shown in FIG. 1b through one or more electronic devices. The one or more electronic devices include, but not limited to, a mobile phone, a computer and a smart television. The health monitoring device 107 also provides precautions for the detected critical health condition.

FIG. 1c shows a detailed block diagram illustrating a health monitoring device in accordance with some embodiments of the present disclosure.

In one implementation, the health monitoring device 107 receives physiological data from the one or more sensors 103. In one embodiment, the physiological data is stored within the memory 103. In another embodiment, the physiological data is stored in a data store. The data store is associated with the health monitoring device 107. As an example, the data store is a cloud based data store. In an embodiment, the data includes physiological data 117, location data 119, pattern data 121, care provider data 125 and other data 127. In the illustrated FIG. 1c, one or more modules stored in the memory 113 are described herein in detail.

In one embodiment, the data may be stored in the memory 113 in the form of various data structures. Additionally, the aforementioned data can be organized using data models, such as relational or hierarchical data models. The other data 127 may store data, including temporary data and temporary files, generated by modules for performing the various functions of the health monitoring device 107.

In an embodiment, the physiological data 117 is received from the one or more sensors. 103 placed on the subject 101. The sensors 103 monitor physiological condition of the subject 101 and continuously provide physiological data 117 to the health monitoring device 107.

In an embodiment, the location data 119 is received from a GPS module associated with the sensors 103. The GPS module 119 tracks the location of the subject continuously and provides the location information to the health monitoring device 107.

In an embodiment, the pattern data 121 refers to patterns generated by the health monitoring device 107 based on the physiological data 117. The physiological data 117 is analyzed by the health monitoring device 107 to generate one or more patterns. Each of the one or more patterns is associated with time stamp information and location information. As an example, the pattern refers to behavior of the subject 101 at a particular time and at a particular location. The health monitoring device 107 also stores predefined patterns. The predefined patterns are based on previous health history of the subject 101. Each predefined pattern is associated with one or more precautions.

In an embodiment, the care provider data 125 comprises information about one or more care providers of the subject 101. The health monitoring device 107 may preconfigure one or more care providers for one or more locations of the subject 101 as shown in Table 2. The care provider's data also includes information of name of the care providers, address of the care providers, contact details, for example telephone number and e-mail ID of the care providers etc.

In one implementation, the modules may include, for example, a receiving module 129, analysis module 131, GPS module 133, pattern matching module 135, notification module 137 and other modules 139. The other modules 139 may be used to perform various miscellaneous functionalities of the health monitoring device 107. It will be appreciated that such aforementioned modules may be represented as a single module or a combination of different modules.

In an embodiment, the receiving module 129 receives physiological data 117 from the one or more sensors 103. The received physiological data 117 is either stored in the memory 113 of the health monitoring device 107 or in a data store. The physiological data 117 refers to physiological condition of the subject 101.

In an embodiment, the analysis module 131 analyzes the physiological data 117 to generate one or more patterns. Based on the physiological data 117, the health monitoring device 107 generates one or more patterns. The patterns are associated with time stamp information and location information. The patterns are based on the type of the sensor placed on the subject. As an example, if the sensor placed on the subject is blood pressure sensor, then the patterns may be related to blood pressure readings of the subject.

In an embodiment, the GPS module 133 is configured to track location of the subject. The GPS module 133 is associated with the sensors 103 placed on the subject 101. The GPS module 133 tracks the location of the subject 101 continuously and provides location information to the health monitoring device 107.

In an embodiment, the pattern matching module 135 compares the pattern with one or more predefined patterns. The analysis module 131 provides the generated one or more patterns to the pattern matching module 135. The pattern matching module 135 compares the one or more patterns with one or more predefined patterns. If the pattern matches with one of the one or more predefined patterns then the health monitoring device 107 detects critical condition of the subject 101.

In an embodiment, the notification module 137 provides notification about the critical condition of the subject 101 to the subject 101 and also to the care providers of the subject 101. The care providers of the subject 101 are preconfigured for one or more locations of the subject 101. Based on the location, the corresponding care providers are selected to provide the notification. The notification module 137 also indicates one or more precautions for the critical health condition of the subject 101.

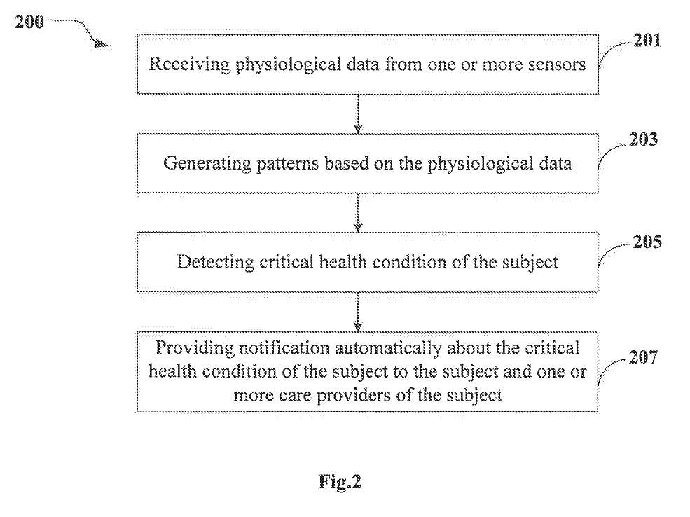

FIG. 2 illustrates a flowchart showing a method for monitoring health condition of a subject in accordance with some embodiments of the present disclosure.

As illustrated in FIG. 2, the method 200 comprises one or more blocks for monitoring health condition of a subject 101 using a health monitoring device 107. The method 200 may be described in the general context of computer executable instructions. Generally, computer executable instructions can include routines, programs, objects, components, data structures, procedures, modules, and functions, which perform particular functions or implement particular abstract data types.

The order in which the method 200 is described is not intended to be construed as a limitation, and any number of the described method blocks can be combined in any order to implement the method. Additionally, individual blocks may be deleted from the methods without departing from the spirit and scope of the subject matter described herein. Furthermore, the method can be implemented in any suitable hardware, software, firmware, or combination thereof.

At block 201, the physiological data 117 is received from one or more sensors 103. In an embodiment, the receiving module 129 of the health monitoring device 107 receives the physiological data 117 from the one or more sensors 103 placed on the subject 101. The received physiological data 117 is either stored in the memory 113 of the health monitoring device 107 or in a data store associated with the health monitoring device 107. The physiological data 117 is about physiological condition of the subject 101 which is monitored using the one or more sensors 103.

At block 203, one or more patterns are generated based on the physiological data 117. In an embodiment, the analysis module 131 of the health monitoring device 107 analyzes the physiological data 117 to generate one or more patterns. Based on the physiological data 117, the health monitoring device 107 generates one or more patterns. The patterns are associated with time stamp information and location information. The patterns are based on the type of the sensor placed on the subject 101.

At block 205, the critical condition of the subject 101 is detected. In an embodiment, the pattern matching module 135 compares the one or more patterns with one or more predefined patterns. If the pattern matches with one of the one or more predefined patterns then the health monitoring device 107 detects critical condition of the subject 101. If the pattern does not match with one of the one or more predefined patterns then the health monitoring device 107 detects normal health condition of the subject 101.

At block 207, a notification about critical condition of the subject 101 is provided. In an embodiment, the notification module 137 provides notification about the critical condition of the subject 101 to the subject 101 and also to the care providers of the subject 101 who are in the vicinity of the location of the subject. The care providers of the subject 101 are preconfigured for one or more locations of the subject 101. Based on the location, the corresponding care providers are selected to provide the notification. The notification module 137 also indicates precautionary measure for the critical health condition of the subject 101.

### Computer System

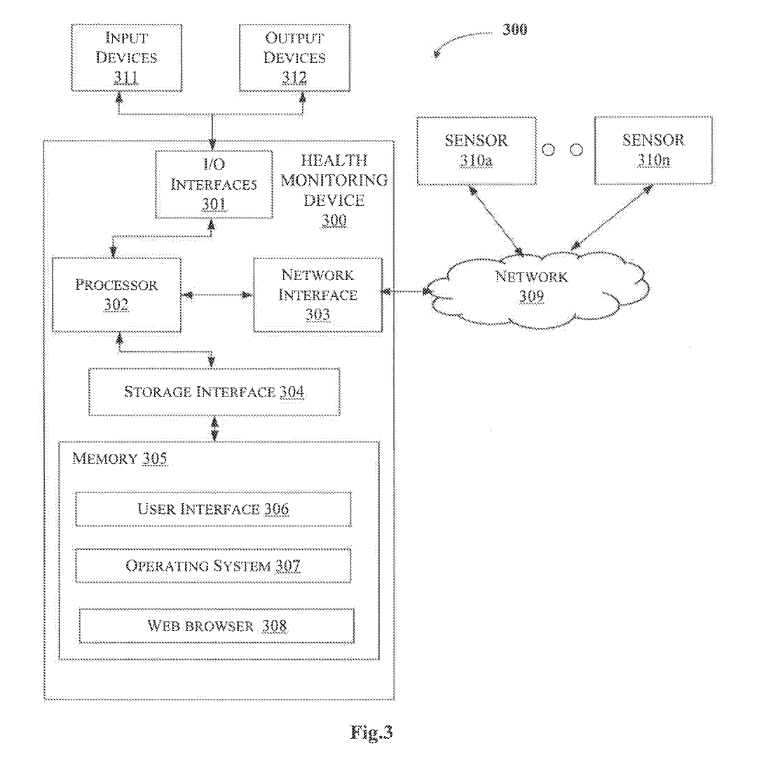

FIG. 3 illustrates a block diagram of an exemplary health monitoring device 300 for implementing embodiments consistent with the present invention. In an embodiment, the health monitoring device 300 is used to monitor health condition of a subject. The health monitoring device 300 may comprise a central processing unit (“CPU” or “processor”) 302. The processor 302 may comprise at least one data processor for executing program components for executing user- or system-generated business processes. A user may include a person, a person using a device such as such as those included in this invention, or such a device itself. The processor 302 may include specialized processing units such as integrated system (bus) controllers, memory management control units, floating point units, graphics processing units, digital signal processing units, etc.

The processor 302 may be disposed in communication with one or more input/output (I/O) devices (311 and 312) via I/O interface 301. The I/O interface 301 may employ communication protocols/methods such as, without limitation, audio, analog, digital, stereo, IEEE-1394, serial bus, Universal Serial Bus (USB), infrared, PS/2, BNC, coaxial, component, composite, Digital Visual Interface (DVI), high-definition multimedia interface (HDMI), Radio Frequency (RF) antennas, S-Video, Video Graphics Array (VGA), IEEE 802.n/b/g/n/x, Bluetooth, cellular (e.g., Code-Division Multiple Access (CDMA), High-Speed Packet Access (HSPA+), Global System For Mobile Communications (GSM), Long-Term Evolution (LTE), WiMax, or the like), etc.

Using the I/O interface 301, the health monitoring device 300 may communicate with one or more I/O devices (311 and 312).

In some embodiments, the processor 302 may be disposed in communication with a communication network 309 via a network interface 303. The network interface 303 may communicate with the communication network 309. The network interface 303 may employ connection protocols including, without limitation, direct connect, Ethernet (e.g., twisted pair 10/100/1000 Base T), Transmission Control Protocol/Internet Protocol (TCP/IP), token ring, IEEE 802.11a/b/g/n/x, etc. Using the network interface 303 and the communication network 309, the health monitoring device 300 may communicate with one or more sensors 310 (a, . . . ,n). The communication network 309 can be implemented as one of the different types of networks, such as intranet or Local Area Network (LAN) and such within the organization. The communication network 309 may either be a dedicated network or a shared network, which represents an association of the different types of networks that use a variety of protocols, for example, Hypertext Transfer Protocol (HTTP), Transmission Control Protocol/Internet Protocol (TCP/IP), Wireless Application Protocol (WAP), etc., to communicate with each other. Further, the communication network 309 may include a variety of network devices, including routers, bridges, servers, computing devices, storage devices, etc. The one or more sensors 310 (a, . . . ,n) may include, without limitation, Blood Pressure monitoring sensor, respiratory rate sensor and temperature sensor.

In some embodiments, the processor 302 may be disposed in communication with a memory 305 (e.g., RAM, ROM, etc. not shown in FIG. 3) via a storage interface 304. The storage interface 304 may connect to memory 305 including, without limitation, memory drives, removable disc drives, etc., employing connection protocols such as Serial Advanced Technology Attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 305 may store a collection of program or database components, including, without limitation, user interface application 306, an operating system 307, web server 308 etc. In some embodiments, computer system 300 may store user/application data 306, such as the data, variables, records, etc. as described in this invention. Such databases may be implemented as fault-tolerant, relational, scalable, secure databases such as Oracle or Sybase.

The operating system 307 may facilitate resource management and operation of the computer system 300. Examples of operating systems include, without limitation, Apple Macintosh OS X, UNIX, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), International Business Machines (IBM) OS/2, Microsoft Windows (XP, Vista/7/8, etc.), Apple iOS, Google Android, Blackberry Operating System (OS), or the like. User interface 306 may facilitate display, execution, interaction, manipulation, or operation of program components through textual or graphical facilities. For example, user interfaces may provide computer interaction interface elements on a display system operatively connected to the computer system 300, such as cursors, icons, check boxes, menus, scrollers, windows, widgets, etc. Graphical User Interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the health monitoring device 300 may implement a web browser 308 stored program component. The web browser may be a hypertext viewing application, such as Microsoft Internet Explorer, Google Chrome, Mozilla Firefox, Apple Safari, etc. Secure web browsing may be provided using Secure Hypertext Transport Protocol (HTTPS) secure sockets layer (SSL), Transport Layer Security (TLS), etc. Web browsers may utilize facilities such as AJAX, DHTML, Adobe Flash, JavaScript, Java, Application Programming Interfaces (APIs), etc. In some embodiments, the health monitoring device 300 may implement a mail server stored program component. The mail server may be an Internet mail server such as Microsoft Exchange, or the like. The mail server may utilize facilities such as Active Server Pages (ASP), ActiveX, American National Standards Institute (ANSI) C++/C#, Microsoft .NET, CGI scripts, Java, JavaScript, PERL, PHP, Python, WebObjects, etc. The mail server may utilize communication protocols such as Internet Message Access Protocol (IMAP), Messaging Application Programming Interface (MAPI), Microsoft Exchange, Post Office Protocol (POP), Simple Mail Transfer Protocol (SMTP), or the like. In some embodiments, the health monitoring device 300 may implement a mail client stored program component. The mail client may be a mail viewing application, such as Apple Mail, Microsoft Entourage, Microsoft Outlook, Mozilla Thunderbird, etc.

Furthermore, one or more computer-readable storage media may be utilized in implementing embodiments consistent with the present invention. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Advantages of the embodiment of the present disclosure are illustrated herein.

In an embodiment, the present disclosure provides a method and device for monitoring health condition of the subject remotely.

In an embodiment, the present disclosure provides a method wherein patterns are detected based on the sensor data and based on the patterns critical condition of the patient is detected. The patterns vary based on time and location of the subject.

In an embodiment, the present disclosure considers situation of the subject as well along with physiological data for detecting health condition of the subject.

In an embodiment, the present disclosure provides notification to care providers of the subject, upon detecting critical condition of the subject, who are in the vicinity of the subject.

The present disclosure provides a cost-effective solution for the localization of the vehicles efficiently since the invention utilizes the exist devices like mobile device already present inside the vehicle along with the user for providing the directions to the user for parking.

The terms “an embodiment”, “embodiment”, “embodiments”, “the embodiment”, “the embodiments”, “one or more embodiments”, “some embodiments”, and “one embodiment” mean “one or more (but not all) embodiments of the invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limiting, of the scope of the invention, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

### REFERRAL NUMERALS

| Reference Number | Description |
|---|---|
| 100 | Environment |
| 101 | Subject |
| 103 | Sensors |
| 105 | Communication Network |
| 107 | Health Monitoring device |
| 109 | I/O interface |
| 111 | Processor |
| 113 | Memory |
| 117 | Physiological Data |
| 119 | Location Data |
| 121 | Pattern Data |
| 125 | Care Provider Data |
| 127 | Other Data |
| 129 | Receiving Module |
| 131 | Analysis Module |
| 133 | GPS Module |
| 135 | Pattern Matching Module |
| 137 | Notification Module |
| 139 | Other Modules |

We claim:

1. A method for monitoring health condition of a subject, the method comprising:
receiving, by a health monitoring device, physiological data from one or more sensors placed on the subject;
analyzing, by the health monitoring device, the physiological data to generate one or more patterns, wherein each of the one or more patterns is associated with time-stamp information and location information of the subject;
detecting, by the health monitoring device, critical health condition of the subject if the one or more patterns match with one of one or more predefined patterns; and
providing, by the health monitoring device, dynamically a notification about the critical health condition of the subject to at least one of the subject and one or more care providers of the subject in the vicinity of the location of the subject.

2. The method as claimed in claim 1 further comprises receiving input from the subject to detect one or more activities responsible for the critical health condition of the subject.

3. The method as claimed in claim 1, wherein each of the one or more patterns and each of the one or more predefined patterns are stored in a data store.

4. The method as claimed in claim 1, wherein each of the one or more predefined patterns is associated with one or more precautionary measures.

5. The method as claimed in claim 4 further comprises notifying the one or more precautionary measures to at least one of the subject and the one or more care providers of the subject.

6. The method as claimed in claim 4, wherein the one or more precautionary measures are associated for each of the one or more predefined patterns of the subject based on previous health report of the subject.

7. The method as claimed in claim 1, wherein the one or more care providers of the subject are predefined for one or more locations of the subject.

8. The method as claimed in claim 1, wherein the location information of the subject is identified using a Global Positioning System (GPS) device associated with the one or more sensors.

9. A health monitoring device for monitoring health condition of a subject, the health monitoring device comprising:
at least one processor; and
a memory storing instructions executable by the at least one processor, wherein the instructions configure the at least one processor to:
receive physiological data from one or more sensors placed on the subject;
analyze the physiological data to generate one or more patterns, wherein each of the one or more patterns is associated with time-stamp information and location information of the subject;
detect critical health condition of the subject if the one or more patterns match with one of one or more predefined patterns; and
provide dynamically a notification about the critical health condition of the subject to at least one of the subject and one or more care providers of the subject in the vicinity of the location of the subject.

10. The health monitoring device as claimed in claim 9, wherein the instructions further causes the processor to receive input from the subject to detect one or more activities responsible for the critical health condition of the subject.

11. The health monitoring device as claimed in claim 9, wherein each of the one or more patterns and each of the one or more predefined patterns are stored in a data store.

12. The health monitoring device as claimed in claim 9, wherein each of the one or more predefined patterns is associated with one or more precautionary measures.

13. The health monitoring device as claimed in claim 12, wherein the instructions further causes the processor to notify the one or more precautionary measures to at least one of the subject and the one or more care providers of the subject.

14. The health monitoring device as claimed in claim 12, wherein the one or more precautionary measures are associated for each of the one or more predefined patterns of the subject based on previous health report of the subject.

15. The health monitoring device as claimed in claim 1, wherein the one or more care providers of the subject are predefined for one or more locations of the subject.

16. A non-transitory computer readable medium including operations stored thereon that when processed by at least one processor cause a health monitoring device to perform the acts of:
receiving physiological data from one or more sensors placed on a subject;
analyzing the physiological data to generate one or more patterns, wherein each of the one or more patterns is associated with time-stamp information and location information of the subject;
detecting critical health condition of the subject if the one or more patterns match with one of one or more predefined patterns; and
providing dynamically a notification about the critical health condition of the subject to at least one of the subject and one or more care providers of the subject in the vicinity of the location of the subject.
